(19) United States
(12) Patent Application Publication
(10) Pub. No.: US 2021/0082048 A1
(43) Pub. Date: Mar. 18, 2021

(54) ITERATIVE MODELING TOOL FOR OPTIMIZING ASSET USAGE

(71) Applicant: The Mortgage Professor, LLC, Gladwyne, PA (US)

(72) Inventors: Jack M. GUTTENTAG, Gladwyne, PA (US); Allan REDSTONE, Bow, WA (US)

(21) Appl. No.: 16/570,711

(22) Filed: Sep. 13, 2019

(51) Int. Cl. G06Q 40/06; G06Q 40/02; G06F 17/18

(52) U.S. Cl. CPC G06Q 40/06; G06F 17/18; G06Q 40/02

(57) ABSTRACT

A computer system is configured to take an iterative approach to solving an optimization problem involving two functions with a shared output and a common constant value. The first function may have discontinuous or non-linear input parameters, and the second function may have a relationship with the common constant value more mathematically complex than a mere summation. By determining an appropriate common constant value, the two functions become equal to each other, within a margin of tolerance, at a specified value of a shared independent input parameter. The computer system iterates on the shared output, solving non-convergence issues associated with iteration directly on the common constant value and improving computational speed. This iterative approach can be applied to solving asset optimization problems in retirement planning that includes deferred annuities.

### BACKGROUND

Embodiments described herein relate to optimization problems involving multiple non-linear and/or discontinuous input parameter functions. Algebraic methods cannot guarantee a solution with maximum or minimum area under the solution curve when the optimization problem comprises non-linear and/or discontinuous input parameters. Although an iterative approach may be used in these situations, not all iterative approaches guarantee a solution that meets the requirements, and may diverge or oscillate. Some iterative approaches require constraints on the inputs that make them impractical for real world applications. Even when an iterative approach is capable of finding a solution, the time taken to reach the solution may be several minutes for an average personal computer system, making it impractical for commercial or personal use.

### BRIEF SUMMARY

A method of determining a deferred annuity purchase amount that comprises: receiving, by a processor, one or more inputs comprising assets, an income pattern, a retiree's age, and an annuity start date; selecting, by the processor, an initial annuity payment corresponding to the annuity start date; generating, by the processor, a periodic withdrawal stream, such that: a total income stream, comprising the periodic withdrawal stream, matches the income pattern, and the total income stream at a period of the annuity start date matches the initial annuity payment; identifying, by the processor, a period number at which the assets remaining, before a withdrawal is made at the period number, are less than the total income stream at the period number, wherein the period number is identified based on drawing an amount corresponding to the periodic withdrawal stream from the assets each period before the period number; comparing, by the processor, the period number to the period of the annuity start date and performing one of: increasing, by the processor, the initial annuity payment in response to the period number falling after the period of the annuity start date; decreasing, by the processor, the initial annuity payment in response to the period number falling before the period of the annuity start date; or setting, by the processor, the deferred annuity purchase amount based on the selected initial annuity payment, the retiree age, and the annuity start date in response to the period number being equal to the period of the annuity start date.

The generating of the periodic withdrawal stream may comprise generating the periodic withdrawal stream based on at least the assets net of the deferred annuity purchase amount.

The method may further comprise excluding a set-aside amount from the assets in the identifying of the period number.

The method may further comprise adjusting, by the processor, the assets available at the period number based on the periodic withdrawal stream and a rate of return on the assets being equal to a first projected rate of return.

The method may further comprise excluding a cushion amount from the assets remaining in the identifying of the period number.

The method may further comprise determining, by the processor, an underperformance probability that the adjusted assets will be drawn to zero by the periodic withdrawal stream at a period number before the identified period number, based on the rate of return being equal to a second projected rate of return that is less than the first projected rate of return; and determining, by the processor, a set-aside amount of the assets based on an amount required to reduce the underperformance probability below a threshold, wherein the set-aside amount is excluded from the assets in the identifying of the period number and included in the assets when determining the underperformance probability.

The method may further comprise determining the set-aside amount by generating a new periodic withdrawal stream based on the first projected rate of return while adjusting the assets based on the second projected rate of return; generating an alternate periodic withdrawal stream comprising the periodic withdrawal stream in a first period before the annuity start date and the new periodic withdrawal stream in a second period before the annuity start date; determining the set-aside amount based on a net present value of a difference between the periodic withdrawal stream and the alternate periodic withdrawal stream; and excluding the set-aside amount from the assets in the identifying of the period number.

The assets may comprise, at least in part, a reverse mortgage, wherein at least a portion of the proceeds from the reverse mortgage are included in one or more of: the annuity purchase amount; a set-aside amount excluded from the assets in the identifying of the period number; a cushion amount excluded from the assets remaining in the identifying of the period number; assets from which the periodic withdrawal stream is drawn, wherein a property rate of return applied to the reverse mortgage in the adjusting of the assets is different from the first projected rate of return.

The period number may correspond to a period number at which the assets are drawn down to zero.

The receiving of one or more inputs may further comprises receiving an input corresponding to a supplemental income stream; wherein the total income stream further comprises the supplemental income stream; wherein the identifying further comprises identifying a period number at which a combination of the supplemental income stream and the assets remaining, before a withdrawal is made at the period number, is less than the total income stream at the period number; and wherein the generating of the periodic withdrawal stream comprises generating the periodic withdrawal stream based on the assets, net of the deferred annuity purchase amount, and the supplemental income stream.

### BRIEF DESCRIPTION OF THE DRAWINGS/FIGURES

FIG. 1 is a flow chart illustrating non-limiting steps of setting an annuity purchase amount based on information about a retiree and the retiree's assets according to embodiments disclosed herein.

FIG. 2 is a flowchart illustrating non-limiting steps of excluding an annuity purchase amount from the assets according to an embodiment disclosed herein.

FIG. 3 is a flowchart illustrating non-limiting steps of adjusting the value of assets based on a first projected rate of return according to an embodiment disclosed herein.

FIG. 4 is a flowchart illustrating non-limiting steps for determining a set-aside amount.

FIG. 5 is a diagram illustrating non-limiting asset usage categories according to embodiments disclosed herein.

FIG. 6 is a chart illustrating how an income pattern is matched to an initial annuity payment to define the total income stream according to an embodiment disclosed herein.

FIG. 7 is a chart illustrating how a non-limiting total income stream may comprise a monthly withdrawal stream from assets, a supplemental income stream, and a reverse mortgage income stream according to an embodiment disclosed herein.

FIG. 8 is a chart illustrating various non-limiting income patterns according to embodiments disclosed herein.

FIG. 9 is a chart illustrating how adjustments of the initial annuity payment affect the month number at which assets are depleted according to embodiments disclosed herein.

FIG. 10 is a swim lane diagram illustrating a non-limiting example of various components of the planning tool according to an embodiment disclosed herein.

FIG. 11 is a block diagram illustrating a non-limiting example of a planning tool system according to an embodiment disclosed herein.

FIG. 12 is a block diagram of a non-limiting example computer system useful for implementing various embodiments disclosed herein.

In the drawings, like reference numbers generally indicate identical or similar elements.

### DETAILED DESCRIPTION

According to embodiments disclosed herein, the goal of an optimization tool may be to match two functions such that the dependent output variables of both functions are equal to each other, within a margin of tolerance, at a specified value of a shared independent input parameter; this may be referred to as the matching condition. The two functions also share a common constant value, such that the area under the first function is inversely related to the common constant value, and the area under the second function is directly related to the common constant value. An optimal solution may, for example, maximize the area under one or both of the functions. One or more of the functions, for example, the second function, may have a complex mathematical relationship with the common constant value, i.e., a relationship that is more than a mere summation shifting the dependent output variable of the second function up or down. By selecting an appropriate common constant value, the functions will intersect, within the margin of tolerance, at the specified value of the shared input parameter. Because one or more of the functions comprises non-linear and/or discontinuous components, an algebraic solution is not guaranteed.

One approach to solving the system may be to use a computer processor and memory to iterate on the common constant value and check the dependent output variable of both functions at the specified value of the shared independent input parameter until a solution is found that satisfies the matching condition within the margin of tolerance. However, because of the discontinuous and non-linear input parameter functions, and the complex mathematical relationship between one of the functions and the common constant value, iterating by adjusting the common constant value may diverge or oscillate, even when the margin of tolerance is relatively large compared to the value of the dependent output variable at the specified value of the shared independent input parameter. Even when a solution is found, iterating on the common constant value to find the solution can take several minutes even with computing parameters optimized.

In this detailed description, an alternate iterative approach is presented. According to embodiments disclosed herein, the processor and memory are configured to iterate on the value of the dependent output variable. The processor and memory are further configured to work backwards from the dependent output variable and determine the corresponding value of the common constant using the complex mathematical relationship between the second function and the common constant. The processor and memory are further configured to use the determined common constant value within the first function. In the first function, the common constant value affects the value of the shared independent input parameter at which the first function meets a threshold condition. The processor and memory are further configured to check for the threshold condition to be met by the first function. The processor and memory are further configured to identify the value of the shared independent input parameter where the threshold condition is met for the first function and compare the identified value to the specified value of the shared independent input parameter, which is the value at which the first and second function should satisfy the matching condition. Based on the difference between the identified value of the shared independent input parameter and the specified value of the shared independent input parameter, the processor increases or decreases the value of the dependent output variable and performs another iteration. Once the identified value is equal to the specified value of the shared independent input parameter and the matching condition is satisfied, the processor and memory has found a solution value of the common constant that satisfies the matching condition for the two functions.

According to one real-world application of the disclosed embodiments, a computer-based planning tool may manage the integration of three major elements of a retirement plan that, elsewhere, are treated separately: financial assets, annuities and reverse mortgages. The financial assets are related to the common constant discussed above. The annuity may be viewed as the second function, which has a complex mathematical relationship with the common constant. The reverse mortgage is an example of one of many possible discontinuous and/or non-linear input parameter functions that make up the first function discussed above. Financial assets may be stocks, bonds, trusts, real estate, cash, cryptocurrency, other investments, or any asset which can be converted to cash or generate income before or during retirement. An annuity is a financial instrument which, in exchange for payment, provides a series of disbursements over a fixed or indefinite period of time. Annuities have the ability to protect against the risk of running out of money at an advanced age by providing guaranteed payments as long as the annuitant is living. A reverse mortgage, or home equity conversion mortgage (HECM), is a financial instrument that allows a homeowner to use the equity in their home to receive payments during retirement. A reverse mortgage may be treated as a distinct type of asset based on a difference from other assets in the rate of return on the reverse mortgage.

Planning for financial support during retirement can be a complex process that may require managing multiple sources of financial assets, accounting for unknown growth rates of various types of assets, dealing with unpredictable fluctuations in earned income, and finding a balance between spending and the risk of premature depletion of assets. A large portion of the difficulty of the retirement planning process comes from complexity in analyzing the various options available. Tools for assisting retirees in making retirement decisions fail to consider the full range of financial instruments available or are focused on the details of just one particular financial instrument available to retirees. Due to limitations of typical consumer hardware, implementation of more powerful tools capable of more complete analysis can lead to impractically long runtimes, or even failure to generate a result.

By integrating these components under management of a single planning tool, however, the disclosed embodiments assist a user in planning for financial support during retirement. The resulting plan is structured to guarantee income for the life of the retiree and maintains maximum smooth or consistent income even when funding sources change or performance of the retiree's assets fails to meet expectations. Changes in funding sources and unpredictable performance of the retiree's assets are two characteristics of real world scenarios that create non-linear and/or discontinuous input parameters. The requirement for maximum smooth income is achieved by meeting the matching condition between the annuity income (e.g., the second function) and the discontinuous and non-linear sources of income (e.g., the first function) the retiree may need to rely on before the annuity payments begin. The implementation of these and other features is described below with reference to the figures. The planning tool may be used by the retiree directly, or used by a financial advisor or other user assisting the retiree. Therefore, the term user, as used in this specification, may refer to the retiree when the retiree uses the planning tool directly, while the term retiree refers to the retiree regardless of who uses the planning tool.

According to embodiments disclosed herein, the planning tool may account for inflation and provide risk-assessment guidance to the user in the form of distributions of rates of return for pools of assets similar to the retiree's assets. The disclosed embodiments allow for flexibility in defining how assets are used for retirement planning. For example, the planning tool may treat a reverse mortgage as a supplemental income stream, as a line of credit to draw from when other assets do not perform as expected, or as at least part of the funds allocated to the purchase of an annuity. The disclosed embodiments of the planning tool may take into account the retiree's sources of funds, financial assets, home value, marital status, and age and, depending on the options and settings chosen, find an optimal division of assets between purchase of an annuity and generating retirement income before the initial annuity payment. In determining an optimal division of assets, the planning tool may seek to secure continuous smooth income and to maximize income during retirement while managing risk of premature asset depletion according to user preferences. The disclosed embodiments may model multiple scenarios using different combinations of options and risk assumptions and present graphical time series representing these scenarios to assist in planning and decision making.

The embodiments are described in terms of one-month periods or increments of time for illustration purposes only. A person of ordinary skill in the art would understand that any period or increment of time may be used, including, but not limited to, daily, weekly, bi-weekly, quarterly, or annually. Therefore, the monthly withdrawal stream may be more generally expressed as the periodic withdrawal stream and months may be more generally expressed as periods. One goal of the disclosed embodiments is to receive information about a retiree's assets and recommend an optimal division of the assets between purchase of an annuity and generating retirement income before the annuity payments begin. Income generated before annuity payments begin may have various non-linear and/or discontinuous input components and relates to the first function, while the annuity payments relate to the second function. The annuity purchase amount may be viewed as the common constant shared between the two functions and the goal in this application of the disclosed embodiments is to find the optimal value of annuity purchase amount that allows the matching condition to be satisfied for the functions representing income before and after the first annuity payment. The annuity may guarantee payments for the life of the retiree to address the risk of the retiree's assets being depleted before the end of the retiree's lifetime. One natural consequence of purchasing an annuity is reduced assets available for generating income before the first annuity payment begins. Therefore, an optimal division of assets may also provide for what is referred to herein as smooth income.

Smooth income avoids large changes in retirement income between the first month of annuity payments and the last month of income generated by assets. A smooth income may also avoid large fluctuations in income before or after annuity payments begin. Smooth income may allow fluctuation in retirement income from month to month, within a margin of tolerance. The planning tool may accept input from the user defining this margin of tolerance or default to a margin of tolerance greater than or equal to zero. If assets that are not allocated to purchase an annuity are drawn down to zero before the first annuity payment, an optimal division of assets would also provide maximum retirement income for the retiree.

In order to understand the value of the disclosed embodiments, it may be helpful to briefly discuss some alternate embodiments of the planning tool that illustrate the difficulties in planning retirement income that meets the requirements of maximum smooth income.

According to one embodiment, a closed form algebraic function may be used to find an optimal division of assets. The closed form algebraic function works only as long as monthly draws from financial assets are constant or linear and the rate of return on assets is constant. Unfortunately, these conditions hold true for very few retirees. Retirees may have sources of supplemental income besides assets, such as employment income, that is discontinuous. Therefore, for many retirees, the withdrawals from assets are not constant. Retirees may also want an income pattern that is non-linear. For example, a retiree may expect a U-shaped spending pattern with high spending at the beginning of retirement that decreases initially and increases again later. A linear total income stream fails to meet the practical needs of some retirees. Additionally, fluctuations in the stock market, interest rates, and real estate prices mean the rate of return on financial assets is rarely constant. Also, for many retirees, their home is a significant portion of their assets and reverse mortgages give retirees a flexible source of retirement income that is not necessarily constant. These factors create circumstances where a closed form algebraic approach is inappropriate for finding an optimal annuity purchase amount.

An iterative approach to finding an optimal annuity purchase amount has the potential to accommodate the real world conditions that retirees encounter. According to an embodiment, the planning tool may generate a total income stream schedule that includes income from assets, supplemental income, and income from a reverse mortgage to simulate retirement income requirements. The planning tool may check for smoothness of the total income stream by checking whether the difference between the first annuity payment and the income from all sources at the final month before annuity payments begin is zero; and check whether retirement income is maximized by checking whether the assets remaining at the first annuity payment are zero. If this matching condition is satisfied, the product of the assets remaining and the difference in income before and after annuity payments begin will be zero.

According to an embodiment, the planning tool may iterate on an annuity purchase amount and adjust the annuity purchase amount up or down until the matching condition is satisfied. Although this approach works when supplemental income and reverse mortgages are not considered and the income pattern is constant or constantly increasing, the process can take several minutes to simulate various scenarios with different rates of return on the assets, even with optimized threading on a multi-core CPU. In addition, when iterating on different values of the annuity purchase amount, the planning tool may occasionally fail to converge on a solution when considering discontinuous sources of supplemental income.

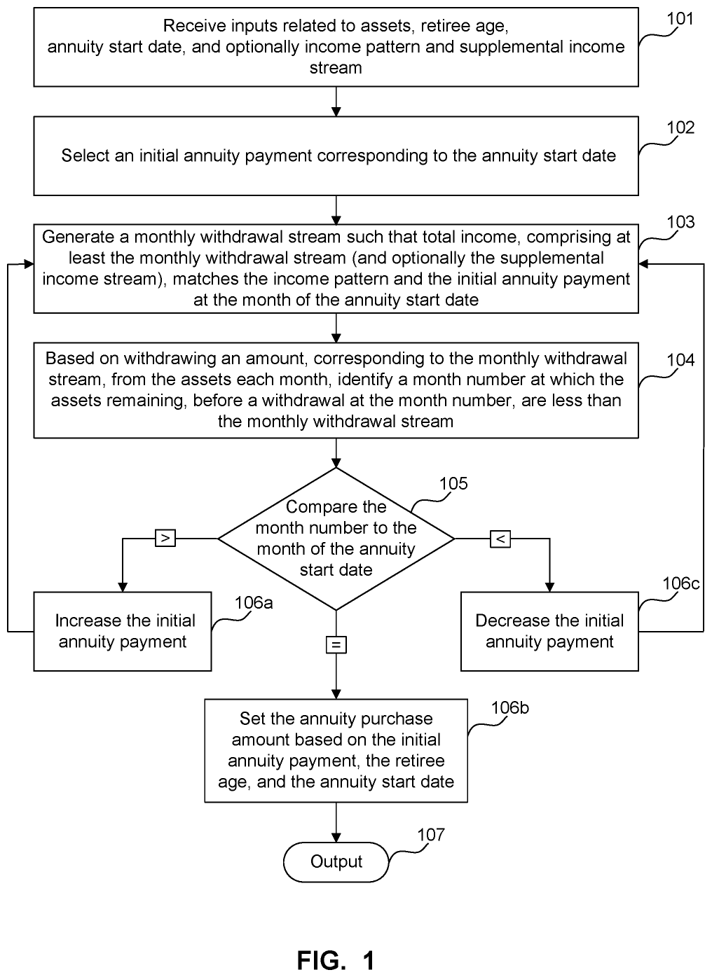

FIG. 1 is a flow chart illustrating non-limiting steps of automatically setting an annuity purchase amount based on information about the retiree and the retiree's assets according to embodiments disclosed herein.

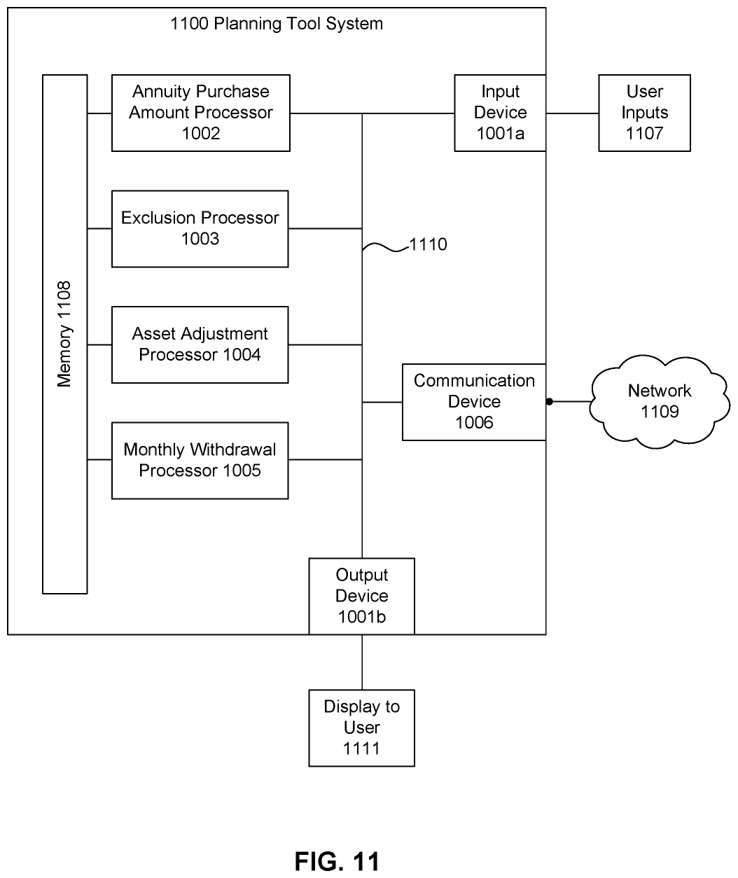

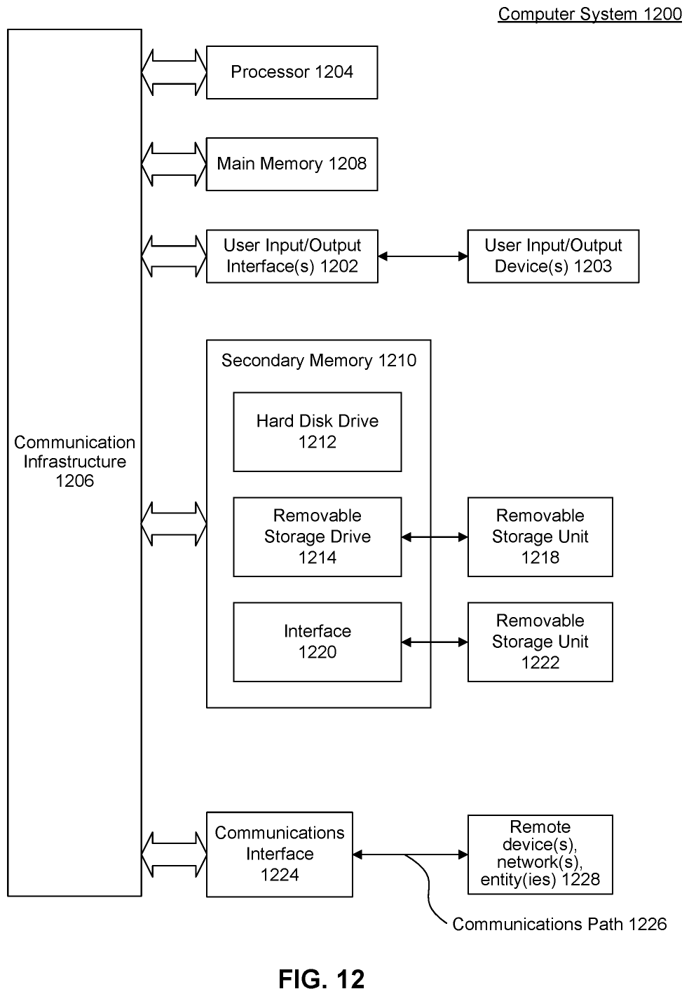

The method of the planning tool illustrated in FIG. 1 may be implemented using a computer system comprising one or more processors and memory. The computer system may be self-contained, distributed, or virtual. Access to the computer system resources may be provided locally, through a network interface, or through a cloud computing platform. A person of ordinary skill in the art would understand that the computer system used to implement the disclosed embodiments of the planning tool may be any system capable of performing calculations, and non-limiting examples of computer systems suitable for implementing the disclosed embodiments are described with reference to FIG. 11 and FIG. 12.

According to a non-limiting embodiment illustrated in FIG. 1, at step 101, the planning tool receives inputs related to assets, retiree age, and annuity start date. The planning tool may also optionally receive input corresponding to one or more of an income pattern or a supplemental income stream.

Assets may be stocks, bonds, trusts, real estate, cash, cryptocurrency, a reverse mortgage, other investments, or any asset which can be converted to cash or generate income before or during retirement. The supplemental income stream may be employment income, social security payments, pensions, income from trusts, income from previously purchased annuities, or income from a reverse mortgage. Throughout this description, the term “assets” is treated as distinct from “supplemental income stream.” One way of making a distinction between assets and a supplemental income stream is based on the availability of the funds: funds categorized in the supplemental income stream are available at particular time period, month, age of the retiree, or structured as a periodic disbursement of funds. In the availability sense, funds from a trust, that earn periodic interest but are dispersed only at regular intervals, may be treated as supplemental income. On the other hand, to the extent that supplemental income can be converted to a lump sum or used more flexibly in time, such a source of supplemental income may be categorized as an asset. Trusts and reverse mortgages are non-limiting examples of sources of income that may be treated as part of a supplemental income stream or an asset, depending on how the disbursement of funds is structured.

The supplemental income stream may be zero in one or more months before the annuity start date and may default to zero if no supplemental income stream input is provided. The income pattern defines the shape of retirement income during retirement and may be flat, linearly increasing, linearly decreasing, exponentially increasing or decreasing, U-shaped, inverted U-shaped, or follow any other function the user may define. A function representing the income pattern defines, at least, how the retirement income increases or decreases during retirement but does not necessarily define specific values of income for each disbursement of income during retirement. The planning tool uses the income pattern in determining how monthly income, defined by the total income stream, changes over time. If no income pattern is selected or input by the user, the planning tool may default to flat, linearly increasing, linearly decreasing, U-shaped, inverted U-shaped, or any other income pattern available to the planning tool.

In some embodiments, the annuity start date may not be required as an input and may, instead, default to the earliest age at which an annuity can be annuitized, based on the retiree's current age. In this case, the retiree's age would be required as an input in order to select an appropriate annuity start date. The retiree age is relevant to determining annuity pricing and may impose a lower bound on the length of a deferment period. The deferment period is a portion of the retirement period before the month of the initial annuity payment. The retirement period, as used in this description, may begin at a time before the deferment period or begin at the same time as the deferment period, comprises the deferment period and an annuity period, and may last for the remainder of the retiree's life. The annuity period begins at the month of the initial annuity payment and may last for the remainder of the retiree's life. One or more of the retirement period, the deferment period, or the annuity period may be defined based on user input. The shared independent input parameter in this particular application is time, and the month of the annuity start date represents the specified value of the shared independent input parameter.

In addition to inputs related to the retiree's age, the planning tool may optionally also receive inputs related to a second party, such as the retiree's spouse. Because some annuities allow the annuitant's spouse to be a beneficiary or co-annuitant of the annuity, information about the retiree's spouse may be beneficial. Additional optional inputs may be related to the retiree's gender, the spouse's gender, the spouse's age, the health of the retiree or the retiree's spouse, or any other information related to pricing the annuity or relevant to determining the expected life of the retiree or the retiree's spouse.

At step 102, the planning tool selects an initial annuity payment. In this application of the disclosed embodiments, the initial annuity payment represents the dependent variable of the second function. The initial annuity payment has a complex mathematical relationship to the annuity purchase amount through the retiree age and annuity start date; and the annuity purchase amount can be calculated given the initial annuity payment, retiree age, and annuity start date. The initial annuity payment represents the amount that an annuity would pay at the first period of annuitization. The first period of annuitization is the specified value of the shared independent input parameter. The selection of the initial annuity payment by the tool at step 102 serves as a seed input (e.g., starting point, estimate, or guess) used to begin the iterative process of determining an optimal annuity purchase amount considering the inputs and preferences of the retiree. Because the planning tool iteratively adjusts the initial annuity payment, the planning tool converges on a final optimal value for the initial annuity payment. Therefore, the method of choosing the initial annuity payment will not affect the final value selected for the initial annuity payment or the final value selected for the annuity purchase amount.

The initial annuity payment may be determined by a variety of methods. According to an embodiment, the initial annuity payment may be determined based on a portion of the financial assets divided by the deferment term in months. The portion of the financial assets used in determining the initial annuity payment may be the total financial assets. Alternatively, the portion of the financial assets used in determining the initial annuity payment may be based on the annuity start date and the retiree's age. As a non-limiting example, the retiree may be 65 years old with an annuity start date set 10 years in the future. If the life expectancy of the retiree is 80 years, the annuity would represent one-third of the retiree's retirement. In this situation, the initial annuity payment may be one-third of the retiree's assets divided by the deferment term in months. In an alternative embodiment, the initial annuity payment may be determined randomly. The initial annuity payment may be constrained by the total value of the assets input to the planning tool.

In an alternative embodiment, an annuity purchase amount may be determined and an initial annuity payment determined based on the annuity purchase amount, retiree age, and annuity start date. The planning tool may estimate the initial annuity payment based on a mathematical relationship between the initial annuity payment and the annuity purchase amount, or the planning tool may retrieve an initial annuity payment by communication with a third party, such as through a network connection. Because the annuity purchase amount and initial annuity payment may be determined from each other, any method used to determine the initial annuity payment may also be used to determine the annuity purchase amount. According to an embodiment, the planning tool excludes the annuity purchase amount from the assets at some time before or during the performance of step 104.

In step 103, the planning tool generates a monthly withdrawal stream such that the total income stream, comprising at least the monthly withdrawal stream, matches the income pattern and the initial annuity payment at the month of the annuity start date. The total income stream may be viewed as the first function having various non-linear and discontinuous components or input parameters.

The monthly withdrawal stream defines a series of monthly withdrawals to be drawn from the assets in the deferment period. The period of the withdrawals is typically monthly. A person of ordinary skill in the art would recognize that other periods may be used. The monthly withdrawal stream may include months with a withdrawal amount of zero, and therefore, the deferment period may include months where no withdrawal is planned. The deferment period defines the time during which withdrawals are made from the assets and may last for the remainder of the retiree's life. The deferment period may be defined by user input. The planning tool may define the monthly withdrawal stream, with specific values for each month of the deferment period, based on the income pattern, the initial annuity payment, and the supplemental income stream.

The total income stream refers to the planned total stream of income during retirement, and may comprise income from multiple sources, including assets, supplemental income, reverse mortgage payments, or payments from a previously purchased annuity. The total income stream may comprise one or more of the monthly withdrawal stream or a supplemental income stream. Depending on the type of reverse mortgage, reverse mortgage income may be treated either as an asset or as supplemental income. Any of the monthly withdrawal stream, the supplemental income stream, or the reverse mortgage income may be zero at one or more months during the retirement period.

According to an embodiment, the planning tool may generate the monthly withdrawal stream based on the difference between the total income stream and the supplemental income stream. If the supplemental income stream exceeds the total income stream at any given month, the planning tool may add the excess funds to the assets or increase the total income, within the margin of tolerance.

The income pattern defines the shape of retirement income during retirement. The shape of the income during retirement may be flat, linearly increasing, linearly decreasing, exponentially increasing or decreasing, U-shaped, inverted U-shaped, or follow any other function the user may define. The function representing the income pattern defines, at least, how the retirement income increases or decreases during retirement. The planning tool may generate the total income stream by using the income pattern to define the shape of the total income stream and using the initial annuity payment to set the total income stream to a particular value at the month of the initial annuity payment. Once the planning tool sets the value of the total income stream, at the month of the initial annuity payment, to the initial annuity payment, the values at the remaining months of the total income stream are constrained by the shape of the income pattern. In this manner, the planning tool treats the matching condition as satisfied between the first function (total income stream) and second function (annuity income); the two functions are treated as equal to each other at the specified value of a shared independent input parameter (e.g., the month of the annuity start date).

According to one embodiment, the planning tool matches the total income stream to be equal to the initial annuity payment, within a margin of tolerance. The margin of tolerance may be greater than or equal to zero. According to one embodiment, the margin of tolerance may be $10. According to another embodiment, the margin of tolerance may be $100. The margin of tolerance may also be defined or adjusted by the user of the planning tool. The margin of tolerance may be defined as an absolute value, such as $10 or $100, or may be a percentage. A person of ordinary skill in the art would understand how to set an appropriate margin of tolerance that meets the needs of the retiree. The matching of the total income stream to the income pattern or initial annuity payment need not be exact, and matching is considered to be accomplished according to the requirements of the disclosed embodiments when the total income stream is constrained by one or both of the initial annuity payment or the income pattern.

According to an embodiment of step 103, an initial set of values for the monthly withdrawal stream may be generated based on the income pattern and the initial annuity payment and then modified based on the supplemental income stream. As a non-limiting example of this approach, the monthly withdrawal stream may be initially treated as being equal to the total income stream at all months, i.e., the total income stream may be temporarily assumed to include only the monthly withdrawal stream in this non-limiting example. The planning tool may set the monthly withdrawal stream or total income stream to be equal to the initial annuity payment, within the defined margin of tolerance, at the month of the initial annuity payment; the remaining months of the monthly income stream or total income stream may then be defined based on the income pattern. At this point, the planning tool may take the supplemental income stream into consideration and, at each month, reduce the monthly withdrawal stream by an amount equal to the supplemental income stream or reverse mortgage income or both. If the supplemental income stream exceeds the total income planned for any given month, the planning tool may add the excess funds to the assets. By this process, the planning tool generates a monthly withdrawal stream such that the total income stream matches the income pattern and the initial annuity payment. Depending on the assets available and a rate of return on those assets, the monthly returns on the balance of the assets may partially or completely offset the monthly withdrawals.

The planning tool then proceeds to identify a value of the shared independent input parameter (a month) at which the first function meets a threshold condition. According to an embodiment, at step 104, based on withdrawing an amount corresponding to the monthly withdrawal stream from the assets each month, the planning tool identifies a month number at which the assets remaining, before a withdrawal is made at the month number, are less than the monthly withdrawal stream. The withdrawing of the assets may be simulated by a processor of the planning tool by reducing the value of the assets stored in memory according to the monthly withdrawal stream. According to an embodiment, the planning tool excludes the annuity purchase amount from the assets at some point before or during the performance of step 104. The assets from which the annuity purchase amount has been excluded may be referred to as withdrawal assets.

According to an embodiment, the identified month number is the first month number at which a withdrawal, if executed, would reduce the assets to zero or less. In other words, asset depletion occurs when the monthly withdrawal stream at the identified month number is greater than the assets remaining. Alternatively, this threshold condition may be expressed as the sum of assets remaining and supplemental income stream being less than the total income stream. The threshold condition that the assets remaining are less than the monthly withdrawal stream captures a broad range of possible situations, including the assets being drawn to zero at or before the identified month number. As a non-limiting example, the assets may be drawn to zero before the identified month number and the requirements of the total income stream may be met by the supplemental income stream. In this situation, the monthly withdrawal stream generated by the planning tool would be set to zero for each month where the supplemental income stream is equal to or greater than the total income stream; and the identified month number would be the first month number at which the supplemental income stream is less than the total income stream and the assets remaining are less than the monthly withdrawal stream.

According to another embodiment, a margin of tolerance may be allowed in the difference between the assets remaining and the monthly withdrawal stream. As a non-limiting example, the assets remaining may be less than, but within $10 of the monthly withdrawal stream. Therefore, if the assets remaining are less than the monthly withdrawal stream, but within the margin of tolerance, the threshold condition of the assets remaining being less than the monthly withdrawal stream may be considered not to be met. When a margin of tolerance is applied, the threshold condition of step 104 is met when the supplemental income stream is less than the total income stream, the assets remaining are less than the monthly withdrawal stream, and the difference between the assets remaining and the monthly withdrawal stream is greater than the margin of tolerance. The threshold condition that the monthly withdrawal stream is greater than the assets remaining within the margin of tolerance may be referred to as the asset depletion threshold.

The margin of tolerance may be defined or adjusted by the user of the planning tool or set to a predetermined value by default. According to one embodiment, the margin of tolerance may be $10. According to another embodiment, the margin of tolerance may be $100. The margin of tolerance may be defined as a fixed value, such as $10 or $100, or may be a percentage. A person of ordinary skill in the art would understand how to set an appropriate margin of tolerance that meets the needs of the retiree under a variety of circumstances. The planning tool may apply a margin of tolerance to the matching of the total income stream to the income pattern and initial annuity payment, or to the identification of a month number that meets the threshold of asset depletion, or at any point in the embodiments described herein.

At step 105, the planning tool compares the identified month number to the month of the annuity start date. In this particular application of the disclosed embodiments, this comparison is part of the test for whether the matching condition has been satisfied for the two functions. The month of the annuity start date is the month of the initial annuity payment. This identified month number may be viewed as the month number at which the retiree would require annuity payments to begin in order to maintain a monthly income consistent with the planned total income stream. If the identified month number is greater than the month of the annuity start date, this means the identified month number occurs, in time, after the annuity start date, and the planning tool proceeds to step 106a and increases the initial annuity payment.

Increasing the initial annuity payment has the effect of increasing the annuity purchase amount, which requires a comparatively larger portion of the assets. Allocating a larger portion of the assets to the annuity purchase amount decreases the assets available to withdraw funds from during the deferment period and increases amount withdrawn from the assets each month, which shifts the month at which assets are depleted to an earlier month.

If the identified month number occurs earlier in time than the month of the initial annuity payment, indicated by the less-than sign in FIG. 1, the planning tool proceeds to step 106c and decreases the initial annuity payment. Decreasing the initial annuity payment has the effect of decreasing the annuity purchase amount, allowing more assets to be allocated to income during the deferment period and decreasing the amount withdrawn from the assets each month, which moves the month of asset depletion to a later month.

After either increasing 106a or decreasing 106c the initial annuity payment, the planning tool returns to step 103 and generates another monthly withdrawal stream which, because of the change in the initial annuity payment, is different from the monthly withdrawal stream of the previous iteration. This process repeats until the identified month number is equal to the month of the initial annuity payment.

When the identified month number is equal to the month of the annuity start date, then the matching condition for the two functions is satisfied. The first function represents income before the first annuity payment and the second function represents income after the first annuity payment. The matching condition is satisfied when the monthly withdrawal stream generated by the planning tool maximizes, within the margin of tolerance, the total income stream. Because the planning tool generates the monthly withdrawal stream so that the total income stream matches the income pattern and the initial annuity payment, the transition from the assets as a source of income to the annuity payments as a source of income is smooth, meaning the change is no more than the margin of tolerance set by the user.

Once the planning tool has identified a month number which is equal to the month of the annuity start date, the planning tool, in step 106b, may set or estimate the annuity purchase amount based on the initial annuity payment, the retiree age and the annuity start date. According to another embodiment, the planning tool may retrieve an annuity purchase amount corresponding to the initial annuity payment form a third party, such as an annuity provider. The planning tool outputs the results, including the annuity purchase amount, in step 107. The planning tool may also output the monthly withdrawal stream corresponding to the annuity purchase amount. The output in step 107 may be displaying the results on a screen, sending the annuity purchase amount to annuity providers to receive price quotes, or otherwise presenting or transmitting one or both of the annuity purchase amount and the monthly withdrawal stream to the user, retiree, and/or a third party.

One of the benefits of selecting and iteratively adjusting an initial annuity payment, rather than the annuity purchase amount, is that this approach simplifies the calculations that need to be performed by the processor, and reduces processing time on standard personal computer hardware from several minutes to just a few seconds. This effect comes, in part, because comparing the specified value of the shared independent input parameter to the identified value of the shared independent input parameter at which the threshold condition is satisfied is much simpler than directly determining whether the matching condition is satisfied at every iteration. Likewise, the comparison between month numbers is simpler than determining both whether the difference between total income and the initial annuity payment is zero and whether the assets have reached the required threshold of depletion at the month of the initial annuity payment. In contrast to the often unrealistic scenario of linear total income, continuous supplemental income, and a fixed return on assets, a closed form algebraic solution is insufficient when the goal is to meet the constraints of limited assets and maximum smooth income while accommodating uncertain or variable returns on assets, discontinuous supplemental income streams, reverse mortgages, and more sophisticated income patterns, including non-linear income patterns.

Another benefit of iterating on the initial annuity payment and identifying the month number at which assets reach the required threshold of depletion (threshold condition) is that the planning tool can guarantee convergence on a solution that satisfies the requirements of maximum smooth income (matching condition) even while supplemental income is discontinuous, total income stream is non-linear, and a reverse mortgage income is considered.

As described above, the planning tool is configured to iterate on the dependent variable (initial annuity payment) of the second function (income after the first annuity payment), and check for a threshold condition (asset depletion condition) to be met by the first function (income before the first annuity payment). The planning tool is further configured to identify the independent input parameter value (time in months) at which the threshold condition is satisfied and compare the identified value to the specified value of the shared independent input parameter (annuity start date). The planning tool is configured to increase or decrease the dependent variable (initial annuity payment) and iterate until the matching condition (smooth maximum income) is satisfied, as indicated by the identified input parameter value being equal to the specified value of the shared independent input parameter.

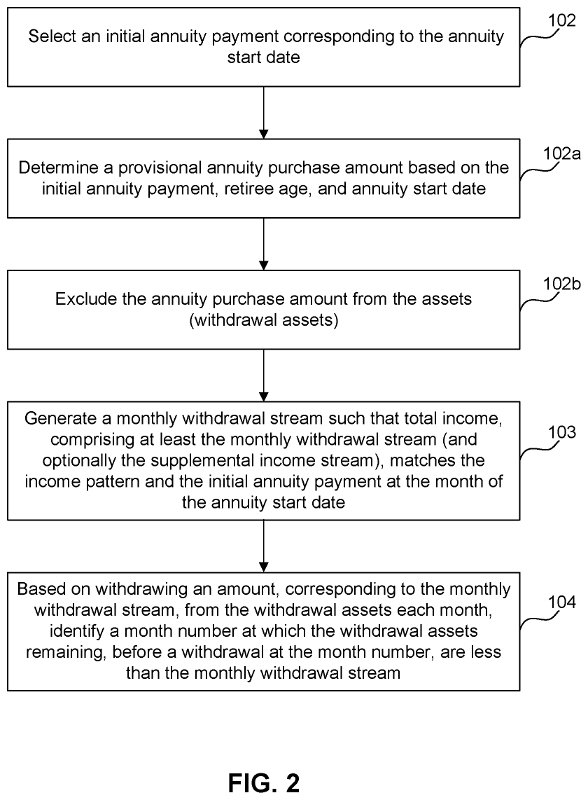

FIG. 2 is a flowchart illustrating non-limiting steps of excluding an annuity purchase amount from the assets according to an embodiment disclosed herein.

Step 102 in FIG. 2 is identical to step 102 in FIG. 1 and, for simplicity, will not be explained further here. At step 102a, the planning tool determines a provisional annuity purchase amount based on the initial annuity payment, retiree age, and annuity start date. The annuity purchase amount may also depend on current interest rates, the life expectancy of the retiree, whether the retiree's spouse is included as an annuitant, or various other features of the annuity. The provisional annuity purchase amount is identified as provisional because the planning tool will change the initial annuity payment associated with the annuity purchase amount with each iteration of the process. When the planning tool selects an initial annuity purchase amount and generates a corresponding monthly withdrawal stream that satisfies the asset depletion threshold at the month of the initial annuity payment, the planning tool sets the annuity purchase amount equal to the provisional annuity purchase amount and outputs the annuity purchase amount. According to an embodiment, the planning tool may also output the monthly withdrawal stream.

At step 102b, the planning tool excludes the provisional annuity purchase amount from the assets. This exclusion of the annuity purchase amount from the assets gives rise to the difference in the relationship the two functions have to the common constant value. The first function (income before the annuity start date) has an inverse relationship to the common constant value (annuity purchase amount) because the annuity purchase amount reduces the assets available for income before the annuity start date. The second function (income after the annuity start date) has a direct relationship to the common constant value because an increase in the annuity purchase amount also increases the initial annuity payment.

The assets remaining after excluding the provisional annuity purchase amount may be referred to as the withdrawal assets. The timing of steps 102a and 102b is flexible and need not happen exactly as depicted in FIG. 2. Step 102a may be performed at any time after the initial annuity payment has been selected and before exclusion of the annuity purchase amount in step 102b. Step 102b may be performed by the planning tool at any time after an annuity purchase amount has been selected or determined and may be performed at any time before step 104, or incorporated into step 104.

Step 102b is intended to be non-limiting and is used only to illustrate the concept that the assets used for purchase of an annuity cannot also be included among the assets to be drawn from during the deferment period. According to one embodiment, the planning tool may exclude the annuity purchase amount from the assets by subtracting the annuity purchase amount from the assets. According to another embodiment, the planning tool may exclude the annuity purchase amount from the assets by setting a threshold that includes the annuity purchase amount, and comparing the assets remaining to the threshold. There are a variety of ways in which the assets or the identified month number may be constrained to accomplish the purpose of avoiding double use of assets.

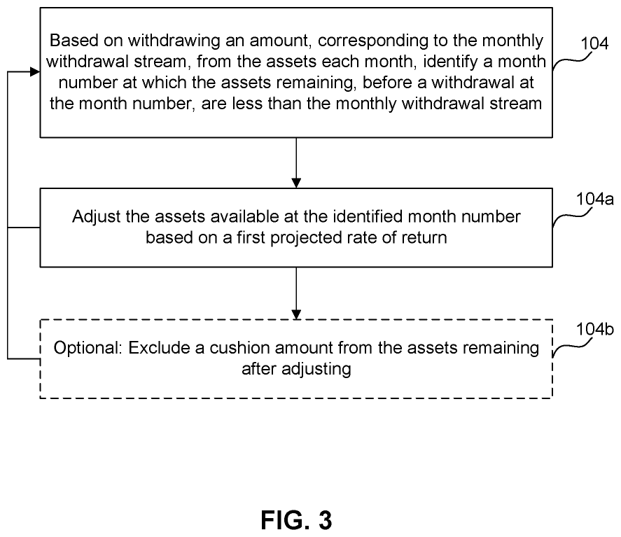

FIG. 3 is a flowchart illustrating non-limiting steps of adjusting the value of assets based on a first projected rate of return according to an embodiment disclosed herein.

According to an embodiment, at step 104a, the planning tool adjusts the value of the assets available at the identified month number based on a first projected rate of return. This asset adjustment represents at least one way in which the first function discussed above may be non-linear. The planning tool may select the first projected rate of return based on historical data accessible to the planning tool, or based on input received from the user. The planning tool may access the historical data from local storage or from a network through a communication device. According to an embodiment, the planning tool adjusts the assets at each month and subtracts the amount withdrawn from the assets each month to identify the month number at which the adjusted assets remaining are less than the monthly withdrawal stream. According to another embodiment, the planning tool may estimate the adjustment using the first projected rate of return and the number of months, or periods of another length, that occur before the identified month number.

According to an embodiment, the threshold condition (asset depletion threshold) is configurable. The planning tool may receive input of an asset depletion threshold and identify a month number at which the assets remaining, or adjusted assets remaining, are less than the asset depletion threshold. The planning tool may set the asset depletion threshold by default to the amount of the monthly withdrawal stream at the identified month number.

According to an embodiment, at an optional step 104b, the planning tool may exclude a cushion amount from the assets remaining after the adjusting of step 104a. The planning tool make receive input of the cushion amount from the user. The cushion amount is an amount which the planning tool will allow to remain in the adjusted assets at the identified month number. The planning tool keeps the cushion amount constant during the asset adjustment process and adds any interest generated by the cushion amount during the deferment period to the assets. In adjusting the assets, the planning tool may compound the interest on the assets, including interest generated by the cushion amount. The cushion amount may be used to mitigate risk of underperformance, as inheritance left to the retiree's beneficiaries, or for any purpose the retiree may have.

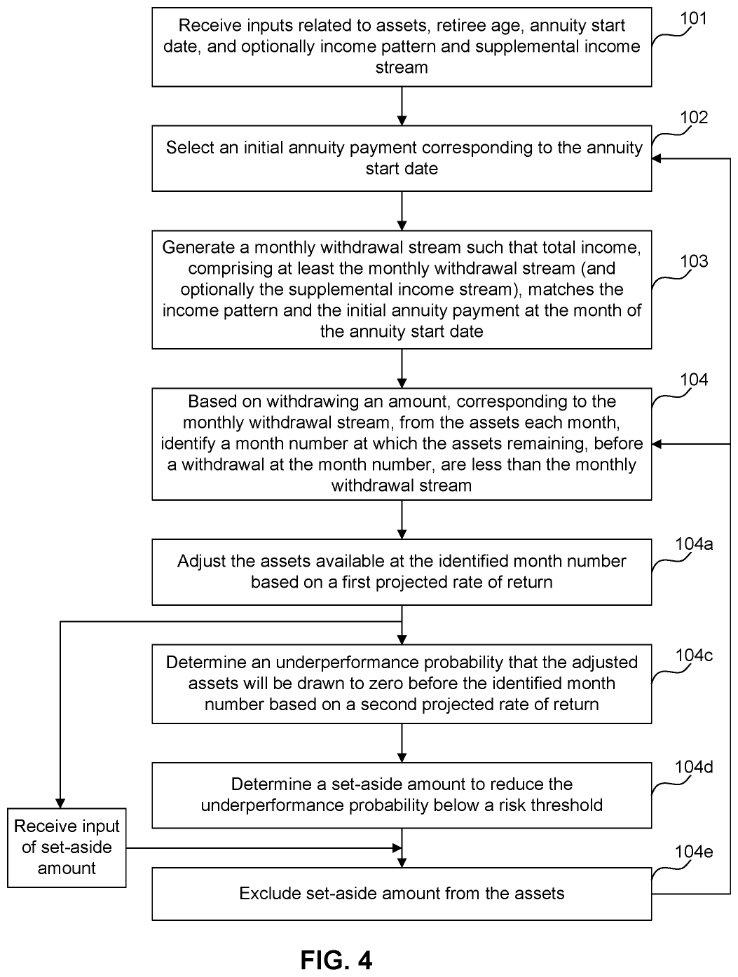

FIG. 4 is a flowchart illustrating non-limiting steps for determining a set-aside amount.

According to an embodiment, the planning tool may determine a set aside amount. A set-aside amount is an amount of the assets that the planning tool excludes from the withdrawal assets when identifying a month number in step 104. The difference between a set-aside amount and a cushion amount is that interest from the set aside amount is added to the set aside amount, while interest from a cushion amount is added to the withdrawal assets. Another way of viewing the difference between a set-aside amount and a cushion amount is that the set-aside amount is excluded from the assets at the beginning of retirement or the beginning of the deferment period; and the cushion amount defines an amount of assets remaining at the end of the deferment period. The set-aside amount may be used by the retiree as a buffer on the assets to absorb unexpected expenses or to mitigate the risk of underperformance of the assets.

Underperformance of the assets may occur when the actual rate of return turns out to be lower than expected.

According to one embodiment, the planning tool may select, using the iterative process described herein, an initial annuity payment based on adjusting the assets using the first projected rate of return. The first projected rate of return may represent the rate of return that the retiree expects to be realized during the deferment period. Having selected an initial annuity payment based on the first projected rate of return, the planning tool may then model monthly withdrawals from the assets while adjusting the assets based on a second projected rate of return that is lower than the first projected rate of return. The second projected rate of return may represent a “bad case” scenario.

After modeling the monthly withdrawal stream, generated based on the first rate of return, against assets adjusted based on the second projected rate of return for some period of time, for example, a year, the planning tool may determine an new monthly withdrawal stream based on the value of the adjusted assets (adjusted based on the second projected rate of return) over the remainder of the deferment period. Because the initial annuity payment is already established, and the withdrawal assets are now less than expected as a result of the “bad case” scenario rate of return, the new monthly withdrawal stream comprises lower monthly withdrawal values than the monthly withdrawal stream generated based on the first rate of return. This readjustment of the monthly withdrawal stream is repeated for each period, for example, each year, creating an alternate monthly withdrawal stream comprising the original monthly withdrawal stream and one or more new monthly withdrawal streams generated based on assets adjusted using the lower second projected rate of return. The planning tool is configured to graphically display the projected value of the withdrawal assets and monthly withdrawal amounts to illustrate this “bad case” scenario.

The set-aside amount may be viewed as the present value of the difference between the withdrawal amounts calculated using the first projected rate of return and the withdrawal amounts calculated using the second projected rate of return. The set-aside amount may be an amount of the assets that would make up for the shortfall in the “bad case” scenario if excluded from the assets when determining the monthly withdrawal amount. Once the set aside amount is determined and excluded from the assets, the planning tool may return to step 102 and select a new initial annuity payment based on the assets with the set-aside amount excluded. The iterative process will quickly converge on a recommended set-aside amount and recommended annuity purchase amount that meets the requirements of the monthly withdrawal stream generated based on the first projected rate of return even when the second projected rate of return is realized.

According to an embodiment, the second projected rate may be a projected pattern of returns that are projected to occur during the deferment period. In addition, the readjustment of the monthly withdrawal stream may be performed on any periodic basis.

Referring to FIG. 4, steps 101, 102, 103, and 104 are identical to the same steps previously described and will not be explained further here. Steps 101, 102 and 104 are repeated in FIG. 4 in order to illustrate the various pathways of the flowchart.

At step 104a, the planning tool adjusts the assets based on a first projected rate of return. At step 104c, the planning tool determines an underperformance probability that the assets will be drawn to zero before the identified month number. One reason the assets might be drawn to zero before the identified month number may be that the actual rate of return realized on the assets is lower than the first projected rate of return. The planning tool may model this situation by performing the asset adjustment based on two or more different projected rates of return. The planning tool may model multiple scenarios using different rates of return and present graphical time series representing these scenarios to the user.

According to an embodiment, the underperformance probability may be determined based on a historical probability corresponding to a second projected rate of return. A person of ordinary skill in the art would recognize that the probability corresponding to any rate of return may be determined by any method used for predicting the future performance of assets, including analysis of historical data, market models, capital asset pricing model, or by receiving a projected rate of return from a third-party.

According to an embodiment, in determining the underperformance probability, the planning tool may consider other factors, such as unexpected medical expenses, natural disasters, the possibility of large purchases during retirement or any other expenses beyond regular living expenses. The relevant aspect of the underperformance probability is that it represents a probability that the assets will be depleted before the month of the initial annuity payment.

At step 104d, the planning tool determines a set-aside amount to reduce the underperformance probability below a risk threshold and excludes the set-aside amount from the assets used in step 104e. The planning tool may set the risk threshold based on input received from the user. Because the set-aside amount changes the amount of withdrawal assets used when determining a month number when the asset depletion threshold is met, the planning tool generates a total income stream and monthly withdrawal stream corresponding to the assets exclusive of the set-aside amount.

According to an embodiment, the planning tool may identify a second month number corresponding to the second projected rate of return. The planning tool may recommend a set-aside amount or cushion amount based on the difference in the withdrawal stream between the first identified month number and the second identified month number. As a non-limiting example, a probability of 90% may correspond to the expected rate of return during the deferment period being greater than or equal to the first projected rate of return, and a probability of 95% may correspond to the expected rate of return during the deferment period being greater than or equal to the second projected rate of return. In order to have a 95% probability that the retiree's assets will not be reduced below zero before the month of the initial annuity payment, the planning tool may use the second projected rate of return when adjusting the assets, and generate a monthly withdrawal stream corresponding to the second projected rate of return. The set-aside amount or cushion amount corresponding to the 95% probability may be determined based on the difference in adjusted assets remaining when the first projected rate of return and second projected rate of return are used for adjusting the assets.

The planning tool may determine an appropriate set-aside amount based on the difference in assets remaining under a variety of scenarios with different rates of return corresponding to different probabilities. As a non-limiting example, the planning tool may generate the monthly withdrawal stream with assets adjusted based on a rate of return representing a bad case scenario and another rate of return representing an average case scenario. The planning tool may then determine the set-aside amount based on the difference in asset consumption under the bad case monthly withdrawal stream and asset consumption under the average case monthly withdrawal stream.

According to an embodiment, the planning tool may identify the month number in step 104 based on a “bad case” scenario first projected rate of return. The planning tool may also recalculate the adjusted assets based on a higher second projected rate of return. The higher second projected rate of return may represent a rate of return closer to the expected or “average case” rate of return. The planning tool may apply the monthly withdrawal stream to both the assets adjusted based on the “bad case” first projected rate of return and the assets adjusted based on the “average case” second projected rate of return, compare the assets remaining at the month of the first annuity payment, and determine the difference between the assets remaining when adjusted based on the first projected rate of return and the assets remaining when adjusted based on the second projected rate of return. The planning tool may determine a net present value of this difference as the set-aside amount.

According to another embodiment, the planning tool may determine an annuity purchase amount based on the “bad case” scenario first projected rate of return. Using the identified month number from the “bad case” scenario, the planning tool may also determine the assets remaining at the identified month number when the assets are adjusted based on the “average case” rate or return. The planning tool may recommend the assets remaining under the “average case” scenario as a cushion amount or recommend the net present value of the assets remaining under the “average case” scenario as a set aside amount. The planning tool may determine the net present value based on the first projected rate of return, the second projected rate of return, or another rate of return received from user input.

According to an embodiment, the planning tool may generate a monthly withdrawal stream and annuity purchase amount for a variety of different scenarios. In addition to the retiree age, and financial asset data, which is common to all scenarios for a particular retiree, each scenario comprises input parameters that are different from each other in one or more of: the first projected rate of return, a second projected rate of return, along with future timing of rates of return, a deferment period, reverse mortgage option, income pattern, cushion amount, or set-aside amount. The first projected rate of return is different from the second projected rate of return in order to allow comparison of different rates of return. The first rate of return may represent an assumed rate of return, or a rate of return representing a risk level the retiree is comfortable with. The second projected rate of return may represent an actual rate of return, materialized rate of return, or a rate of return expected based on any available prediction method.

The planning tool may compute and graphically display representations, such as a time series graph, of assets remaining, monthly withdrawal streams, total income streams, and/or annuity income. The graphical display allows for visual comparison of two or more scenarios. The planning tool may generate computations for multiple scenarios that differ only in a single input parameter and graphically display the representations. The graphical display allows visual comparison of scenarios that is not possible with a tabular or numerical output.

The different rates of return may correspond to different probabilities that the actual rate of return will be greater than or equal to the rate of return applied to each scenario. The planning tool may display or present the variety of different scenarios to the user. According to this embodiment, for a scenario, the planning tool may also indicate one or more probabilities corresponding to rates of return different from the rate of return used in generating the scenario. The planning tool may also display or present an indicator of the risk that the assets will be depleted before the identified month number, given a particular set-aside or cushion amount and the probabilities corresponding to different rates of return. The planning tool may present the various scenarios, with their corresponding probabilities or risk indicators, to the user and receive input selecting a scenario for the retirement plan.

According to an embodiment, the planning tool is further configured to respond to user input selecting a point, line, or range on the graphical representation of a scenario by displaying detailed numerical data associated with one or more scenarios at that selected point. As a non-limiting example, the planning tool may accept touch input, or movement of a displayed cursor to select a point on the graphical display. One of ordinary skill in the art would understand that any known input method may be used to receive user input selecting a point on the graphical representation. The planning tool may display one or more of a scenario identifier, a rate of return associated with the scenario, probability or risk associated with the scenario, assets remaining, income, cushion amount, set-aside amount, annuity pricing, reverse mortgage information, or any other information available to the planning tool. The planning tool may also be configured to display the same information related to a comparison scenario in response to user input selecting a point, line or range on the graphical representation.

According to an embodiment, the planning tool may display a comparison scenario based on the standard 4% rule drawdown of financial assets. When modeled against historical rates of return, the planning tool's method of allocating assets to the purchase a deferred annuity typically outperforms the 4% rule in most historical periods. This performance benefit is possible in addition to the benefit of providing a predictable income stream into retirement until end of life with smooth continuous monthly payments despite changes in funding sources at various points in time.

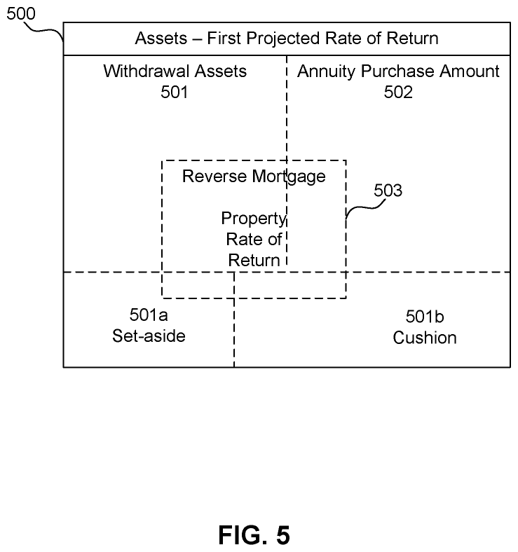

FIG. 5 is a diagram illustrating non-limiting asset usage categories according to embodiments disclosed herein.

Referring to FIG. 5, the assets 500 are represented by a block diagram. The withdrawal assets 501 are assets used for identifying the month number at which the assets remaining are less than the monthly withdrawal stream in step 104. Although the set-aside amount and the cushion amount may be available to the retiree for withdrawals during the deferment period, the planning tool may exclude one or both of a set-aside amount and a cushion amount from the withdrawal assets when determining the month number when the assets depletion threshold is met. This exclusion of the set-aside amount 501a and the cushion amount 501b allows the planning tool to include a buffer in the assets, which reduces the risk of premature asset depletion below a risk threshold set by the user.

The planning tool may allocate the annuity purchase amount for purchase of an annuity and exclude the annuity purchase amount from the assets before or during identification of the month number in step 104. The dotted lines between the different groups of assets represent the flexibility of asset amounts that the planning tool may allocate to each category throughout the iterative process, based on different scenarios with different rates of return, or based on user preferences. During the iterative processes described in FIGS. 1-4, the planning tool may adjust the values of the withdrawal assets 501, the set-aside amount 501a, the cushion amount 501b, and the annuity purchase amount 502.

The reverse mortgage 503 is shown as a dotted box at the intersection of the withdrawal assets 501, the set-aside amount 501a, the cushion amount 501b, and the annuity purchase amount 502 to represent flexibility in the use of funds from the reverse mortgage 503. The reverse mortgage may also have a property rate of return that is different from the rate of return on the rest of the assets 500. Because of the many different structures a reverse mortgage can take, funds originating from a reverse mortgage may be allocated to one or more of the withdrawal assets 501, the set-aside amount 501a, the cushion amount 501b, or the annuity purchase amount 502.

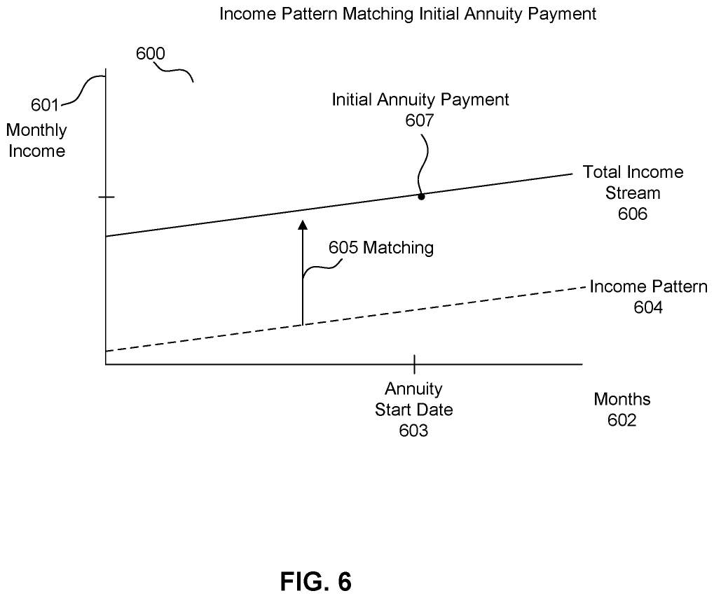

FIG. 6 is a chart illustrating how an income pattern is matched to an initial annuity payment to define the total income stream according to an embodiment disclosed herein.

The chart in FIG. 6 illustrates how a total income stream 606 is matched to the initial annuity payment. The monthly income 601 is shown on the y-axis, and time, in months 602, is shown on the x-axis. For illustration purposes only, the income pattern 604 is shown in FIG. 6 as linearly increasing. The income pattern 604 is shown as a dotted line to indicate that although the shape of the total income stream 606 is defined by the income pattern 604, the value at any particular time, including the month of the annuity start date, is initially unknown.

According to the illustration in FIG. 6, the income pattern may be described as an incompletely defined function. For example, if the income pattern is linearly increasing according to the function y=mx+b, where m is the slope and b is the y-intercept, the slope may be defined while the y-intercept may be left as an unknown constant. The process of matching 605 the total income stream 606 to the initial annuity payment 607 may define the unknown constant in the function representing the income pattern 604 so that the total income stream 606 matches the initial annuity payment at the month of the annuity start date. In effect, this matching process may be described as treating the first function and second function as meeting the matching condition, i.e., the dependent variable values of each function are equal to each other at the specified value of the shared independent input parameter. The iteration process is complete and the matching condition is considered satisfied when the value of the annuity purchase amount corresponding to the initial annuity payment causes the threshold condition (asset depletion threshold) to also be met at the month equal to the specified value of the shared independent input parameter (the month of the initial annuity payment).

As described in relation to FIGS. 1-4, the initial annuity payment is selected at step 102 and adjusted throughout the iteration process. The point representing the initial annuity payment 607 defines an amount of income for the total income stream 606 at the annuity start date 603. However, there are many possible functions, or shapes of the income pattern 604, that may pass through the point representing the initial annuity payment 607. The planning tool may perform matching 605 by setting the value of the income pattern 604 at the month of the annuity start date 603 to be equal to the initial annuity payment 607.

Matching 605 need not necessarily be exact, and the planning tool may satisfy the requirements of matching within a predefined margin of tolerance. The margin of tolerance may be input by the user or set to a default value by the planning tool. The income pattern 604 may be described as defining the shape of the total income stream, or slope in the example of FIG. 6; and the initial annuity payment may be seen as defining a particular value that the income pattern 604 must pass through.

According to various embodiments, the income pattern 604 may be constant, linearly increasing, linearly decreasing, U-shaped, inverse U-shaped, exponential, logarithmic, or any other function, including a function defined by the user. For purposes of this application, a function is defined as a relationship between a set of input values and a set of output values where each input value has exactly one output value; there may be multiple input values that produce the same output value. The total income stream 606 may be represented by a function y=f(x)+c, where y is the total income, f(x) defines the shape of the income pattern, and c shifts the function along the y-axis so that the total income stream equals the initial annuity payment at the month of the annuity start date 603.

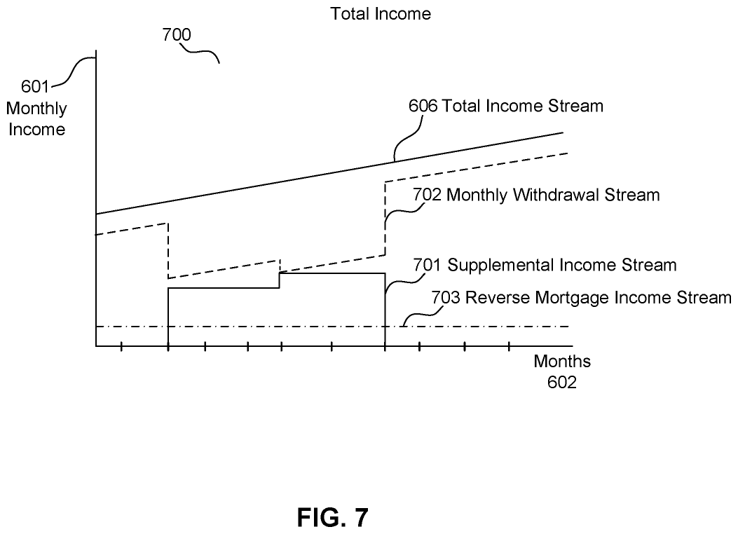

FIG. 7 is a chart illustrating how a non-limiting total income stream may comprise a monthly withdrawal stream from assets, a supplemental income stream, and a reverse mortgage income stream according to an embodiment disclosed herein.

Referring to FIG. 7, the chart of total income 700 has a y-axis representing monthly income 601, and an x-axis representing time in months 602. The total income stream 606 in FIG. 7 is equal to the sum of the monthly withdrawal stream 702, reverse mortgage income stream 703, and the supplemental income stream 701. Depending on how a reverse mortgage is structured, the reverse mortgage income stream 703 may behave similarly to the monthly withdrawal stream 702 or the supplemental income stream 701 and be included in those categories, as appropriate.

In FIG. 7, the total income stream 606 is illustrated corresponding to a linearly increasing income pattern for illustration purposes only. As shown in FIG. 7, the total income stream maintains a linearly increasing shape even when there are fluctuations in the supplemental income stream 701. During months or periods where the supplemental income stream 701 is greater than zero, the planning tool may reduce the monthly withdrawal stream 702 to keep the shape of the total income stream 606 linearly increasing. According to an alternative embodiment, the supplemental income stream 701 may replenish cash assets and the planning tool may generate the monthly withdrawal stream 702 to draw some portion of funds from cash assets, rather than, for example, stocks or bonds, during months where the supplemental income stream 701 replenishes the cash assets. According to another embodiment, planning tool may allocate the monthly withdrawal stream 702 to withdraw funds from assets with the lowest rate of return in order to maximize the average rate of return on the assets.

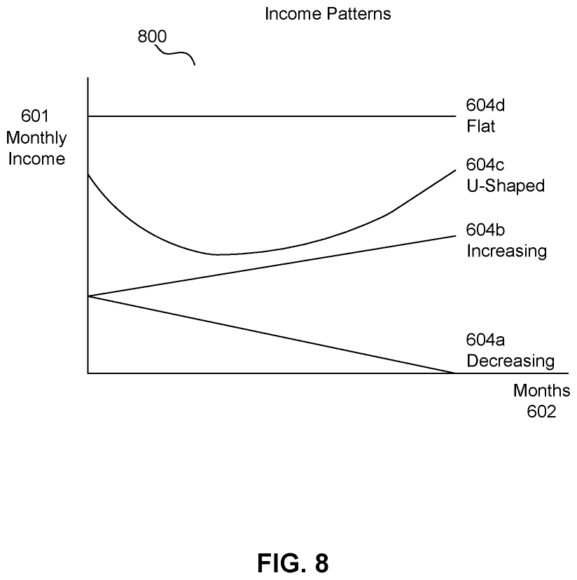

FIG. 8 is a chart illustrating various non-limiting income patterns according to embodiments disclosed herein.

The chart of income patterns 800 illustrates various non-limiting examples of possible income patterns that the planning tool may use in determining the total income stream. The x-axis represents time in months 602, and the y-axis represents monthly income 601. The relative position of the income patterns above or below another income pattern in FIG. 8 is done only for illustration purposes and not intended to indicate that one income pattern corresponds to a higher income than another. The income pattern may be linearly decreasing 604a, linearly increasing 604b, U-shaped 604e, or flat 604d. The income patterns shown are not intended to be exhaustive and a person of ordinary skill in the art would recognize that any shape of the income pattern may be used, and that an income pattern may be represented by any function, and a function may be user-defined.

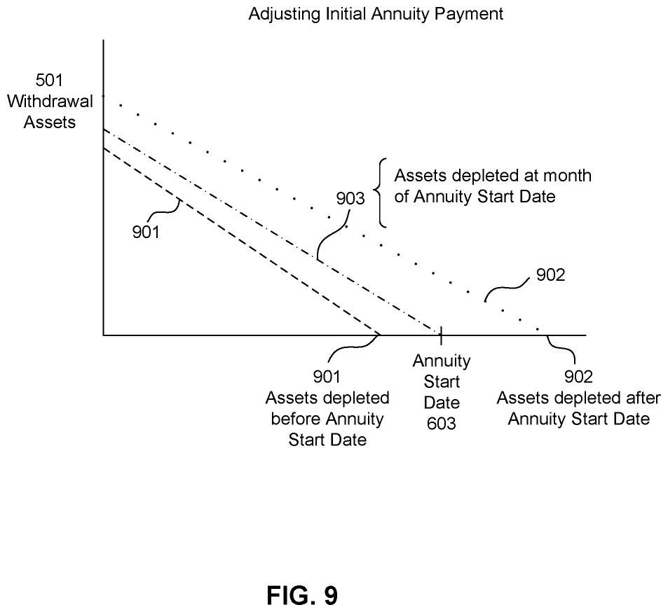

FIG. 9 is a chart illustrating how adjustments of the initial annuity payment affect the month number at which assets are depleted according to embodiments disclosed herein.

For illustration purposes only, the lines showing the value of the withdrawal assets 501 in FIG. 9 are straight, and this is not intended to imply that the depletion of assets is necessarily continuous or linear.

The amount of withdrawal assets is represented by the y-axis and time is represented by the x-axis. The planning tool adjusts the initial annuity payment until the monthly withdrawal stream leads to depletion of the assets at the annuity start date 603, within a margin of tolerance. The line 903 indicates an initial value of the withdrawal assets 501 and asset depletion at the month of the annuity start date 603. When the planning tool adjusts the initial annuity payment, the annuity purchase amount and the amount available for the withdrawal assets 501 also change. When the assets are depleted after the annuity start date 902, the initial annuity payment is too low and the initial value of the withdrawal assets is higher than the line 903, which indicates depletion of the assets at the month of the annuity start date 603. When the assets are depleted before the annuity start date 901, the initial annuity payment is too high and the initial value of the withdrawal assets 501 is less than initial value of the withdrawal assets for the line 903.

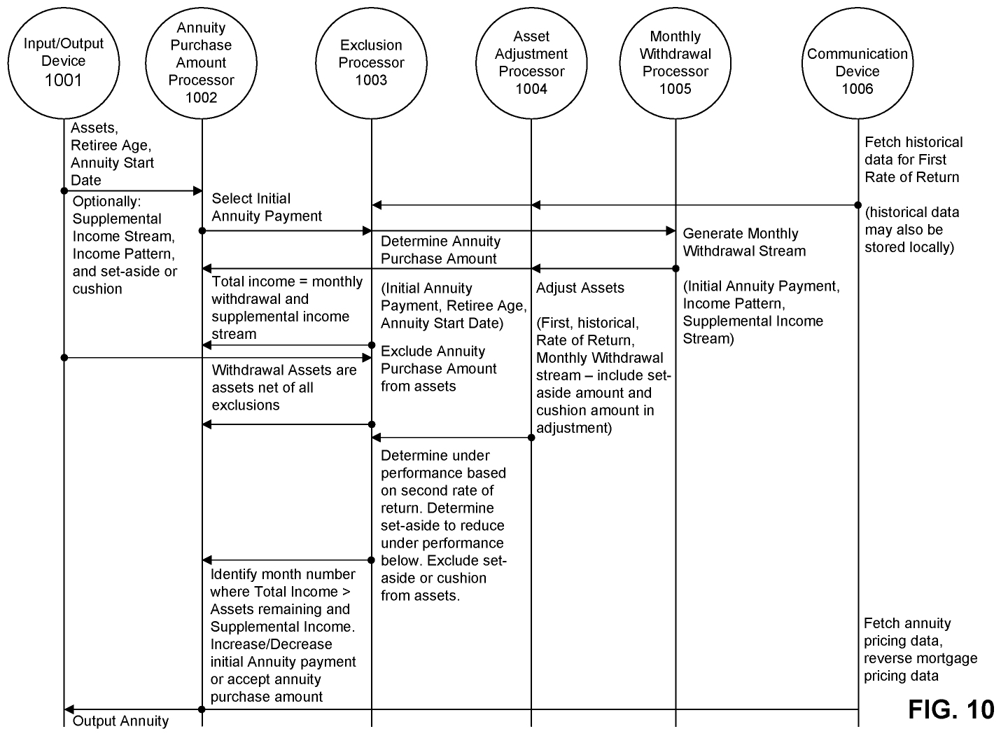

FIG. 10 is a swim lane diagram illustrating a non-limiting example of various components of the planning tool according to an embodiment disclosed herein.

FIG. 10 illustrates the configurations of the various components of the planning tool.

According to an embodiment, the planning tool comprises an input/output device 1001, an annuity purchase amount processor 1002, an exclusion processor 1003, an asset adjustment processor 1004, a monthly withdrawal processor 1005, and a communication device 1006. Each component of the planning tool, after performing its respective operations, makes the result of those operations available to other components of the planning tool, for example, by storing the results in shared-access memory, or by placing the results on a computer system bus.

According to an embodiment, the input/output device 1001 is configured to receive input of the assets, retiree age, and annuity start date. Optionally, the input/output device 1001 may be further configured to receive inputs corresponding to a supplemental income stream, income pattern, set-aside, or cushion. Additionally, the input/output device 1001 is configured to output the determined annuity purchase amount after an annuity purchase amount has been determined by the annuity purchase amount processor 1002. The input/output device 1001 may be further configured to output the monthly withdrawal stream generated by the monthly withdrawal stream processor. The planning tool may be further configured to use predetermined default values if inputs corresponding to the supplemental income stream, the income pattern, or a set-aside or cushion amount are not provided by the user.

The annuity purchase amount processor 1002 is configured to select an initial annuity payment and to make the initial annuity payment available to the exclusion processor. The exclusion processor 1003 is configured to determine an annuity purchase amount based on the initial annuity payment, the retiree age, and the annuity start date. Alternatively, the annuity purchase amount processor 1002 may be configured to determine the annuity purchase amount in addition to selecting the initial annuity payment. Because the annuity purchase amount may be changed before a final result is determined, the annuity purchase amount may be considered a provisional annuity purchase amount. The exclusion processor is configured to exclude the annuity purchase amount from the assets. The annuity purchase amount processor 1002 may also be configured to exclude a cushion amount and a set-aside amount, provided by the user, from the assets. The assets remaining after exclusion of the annuity purchase amount, and optionally the cushion amount and set-aside amount, may be referred to as the withdrawal assets. The exclusion processor may perform exclusion by subtracting from the assets the amount of assets to be excluded or by setting an asset depletion threshold equal to the amount of assets to be excluded. If an asset depletion threshold is used, the assets are considered depleted when the withdrawal assets remaining are less than or equal to the asset depletion threshold.

The monthly withdrawal processor 1005 generates a monthly withdrawal stream that matches the income pattern and is equal to the initial annuity payment at the month of the initial annuity payment, within a margin of tolerance. The margin of tolerance may be predetermined by the planning tool or received as input from the user. The monthly withdrawal processor 1005 makes the monthly withdrawal stream available to the asset adjustment processor 1004.

The asset adjustment processor 1004 is configured to adjust the value of assets available at the month of the initial annuity payment using the monthly withdrawal stream. The assets included in the asset adjustment process may comprise one or more of the withdrawal assets, a cushion amount, a set-aside amount, or a reverse mortgage.

According to an embodiment, the assets included in the adjustment process may also comprise the assets allocated for purchase of an annuity. Because there are a variety of annuities available, and a variety of options for funding an annuity, an optimal timing for purchasing and funding an annuity may depend, in part, on the first projected rate of return on the assets. The planning tool may recommend a particular annuity to purchase or a particular option for funding the annuity, which may include allowing the assets allocated to purchase of the annuity to generate interest before they are used for the annuity purchase in order to maximize the amount of annuity that can be purchased. Although the adjustment of the assets may include one or more of a set-aside amount 501a, a cushion amount 501b, or the annuity purchase amount 502, the planning tool uses only the withdrawal assets when determining the month number at which the assets are considered depleted.

According to an embodiment, the asset adjustment processor 1004 may be configured to make monthly adjustments to the remaining assets based on the first projected rate of return and the withdrawal amount at each month. According to another embodiment, the monthly withdrawal stream processor 1005 may be configured to estimate the adjusted assets available at the month of the initial annuity payment based on the first projected rate of return.

The asset adjustment processor 1004 is further configured to make the adjusted asset values available to the other components of the planning tool. According to an embodiment, the asset adjustment processor may be configured to discontinue adjusting the assets after the assets remaining or withdrawal assets remaining are less than the monthly withdrawal amount; after the assets remaining or withdrawal assets remaining are less than or equal to zero; or after the assets remaining or withdrawal assets remaining are less than the asset depletion threshold. The asset adjustment processor 1004 may be further configured to consider compound interest and variable rates of return. One of ordinary skill in the art would understand that the assets may comprise various asset types and the first projected rate of return may reflect a weighted average of the different rates of return among the assets.

According to another embodiment, the asset adjustment processor 1004 may be further configured to identify the month number at which the withdrawal assets remaining meet the relevant condition of being less than the monthly withdrawal stream, below the threshold amount set by the user, or at or below zero. The asset adjustment processor 1004 may be configured to, for each month, adjust the value of the assets based on the first projected rate of return and the monthly withdrawal stream, and check whether the value of the withdrawal assets meets the relevant condition. According to an embodiment, the asset adjustment processor 1004 is configured to make the identified month number available to the annuity purchase amount processor 1002 or other components of the planning tool.

According to an embodiment, the exclusion processor 1003 is configured to determine a probability of underperformance. The assets may underperform during the retirement period for a variety of reasons, including the actual rate of return being lower than the first projected rate of return. Alternatively, unexpected expenses may deplete the assets at a more rapid rate than anticipated by the planning tool or user of the planning tool.

In order to protect the retiree against the risk of depleting the assets before the month of the initial annuity payment, the exclusion processor 1003 may be configured to determine a probability corresponding to a second projected rate of return that is less than the first projected rate of return. This second projected rate of return may be selected by the user to reflect the risk of unexpected expenses as well as the risk of a rate of return lower than the first projected rate of return.

According to an embodiment, the exclusion processor 1003 is configured to compare the assets remaining, or withdrawal assets remaining, at the identified month number based on one monthly withdrawal stream applied in two or more scenarios with different rates of return used in the asset adjustments. As a non-limiting example, the exclusion processor 1003 may be configured to select two or more different projected rates of return and to generate a monthly withdrawal stream for the lowest rate of return among the different projected rates of return. The exclusion processor 1003 may be further configured to apply the monthly withdrawal stream corresponding to the lowest rate of return and determine the difference in the assets remaining when the different rates of return are applied to the assets. The exclusion processor may be further configured to recommend a set-aside amount or cushion amount, or automatically select or recommend a set-aside amount or cushion amount, based on the difference in assets remaining for two different rates of return. According to an embodiment, the exclusion processor 1003 may set the cushion amount equal to the difference in assets remaining, and may set the set-aside amount equal to the net present value of the difference in assets remaining. The exclusion processor is further configured to exclude the set-aside amount or cushion amount from the assets.

The probability corresponding to a rate of return may be selected, calculated or determined using any method available to those of ordinary skill in the art, or received from a third party. According to an embodiment, the planning tool is configured to select a probability, corresponding to a rate of return, based on the historical probability of the rate of return.

The annuity purchase amount processor 1002 may be further configured to identify the month number when the withdrawal assets remaining are less than the monthly withdrawal stream. Alternatively, the annuity purchase amount processor 1002 may be configured to identify the month number at which the total income stream is greater than the sum of the assets remaining and the supplemental income stream. The annuity purchase amount processor 1002 is further configured to compare the identified month number to the month of the initial annuity payment and: increase the initial annuity payment when the identified month number is greater than the month of the initial annuity payment; decrease the initial annuity payment when the identified month number is less than the month of the initial annuity payment; or make the annuity purchase amount available to the input/output device 1001 in response to the identified month number being equal to the month of the initial annuity payment.

According to an embodiment, a communication device 1006 of the planning tool is configured to fetch annuity pricing data based on the annuity purchase amount, retiree age, and annuity start date. The communication device 1006 may be further configured to fetch reverse mortgage pricing data to assist the user in selecting a reverse mortgage appropriate for the retiree's needs and consistent with the recommendations of the planning tool.

The input/output device 1001 is further configured to output the results. The results may include one or more of the annuity purchase amount, the monthly withdrawal stream corresponding to the annuity purchase amount, annuity pricing data or reverse mortgage pricing data. Output may comprise displaying results to the user, storing the results in computer memory, or transmitting the results to a third party.

FIG. 11 is a block diagram illustrating a non-limiting example of a planning tool system according to an embodiment disclosed herein.

According to an embodiment, the planning tool may be implemented as a computer-based planning tool system 1100 comprising memory 1108, one or more processors for performing the functions of the planning tool, an input device 1001a, an output device 1001b, and a communication device 1006. The processors may be implemented using a single-core processor, a multi-core processor, or separate processors. The processors of the withdrawal planning tool may comprise an annuity purchase amount processor 1002, an exclusion processor 1003, an asset adjustment processor 1004, and a monthly withdrawal processor 1005. The annuity purchase processor is configured to perform the iteration process on the initial annuity payment (the dependent output variable), identify the month number that satisfies the asset depletion threshold (threshold condition), and adjust the initial annuity payment until the matching condition is satisfied, and the month of the asset depletion threshold is equal to the month of the annuity start date. According to one embodiment, the processors 1001, 1002, 1003, and 1004 have shared access to memory 1108 and may be connected to each other and to other components of the planning tool system by a computer system bus 1110.

According to an embodiment, the input device 1001a is configured to receive user inputs 1107, and the output device 1001b is configured to display results to the user 1111. The planning tool system 1100 may also be configured to output results by transmitting the results to a third party, or storing the results in memory 1108. The communication device is configured to communicate with third parties through a network 1109. The communication device may receive historical data related to rates of return for various types of assets, may receive annuity pricing information, and may receive reverse mortgage pricing information. A person of ordinary skill in the art would understand there are a variety of configurations of computer systems that may be used to implement the embodiments disclosed herein and the illustration of FIG. 11 is not intended to be limiting.

FIG. 12 is a block diagram of a non-limiting example computer system useful for implementing various embodiments disclosed herein.

Various embodiments may be implemented, for example, using one or more well-known computer systems, such as computer system 1200 shown in FIG. 12. One or more computer systems 1200 may be used, for example, to implement any of the embodiments discussed herein, as well as combinations and sub-combinations thereof.

Computer system 1200 may include one or more processors (also called central processing units, or CPUs), such as a processor 1204. Processor 1204 may be connected to a communication infrastructure or bus 1206.

Computer system 1200 may also include user input/output device(s) 1203, such as monitors, keyboards, pointing devices, etc., which may communicate with communication infrastructure 1206 through user input/output interface(s) 1202.

One or more of processors 1204 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 may also include a main or primary memory 1208, such as random access memory (RAM). Main memory 1208 may include one or more levels of cache. Main memory 1208 may have stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 may include a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 may read from and/or write to removable storage unit 1218.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224.

Communication interface 1224 may enable computer system 1200 to communicate and interact with any combination of external devices, external networks, external entities, etc. (individually and collectively referenced by reference number 1228). For example, communication interface 1224 may allow computer system 1200 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of determining an annuity purchase amount, the method comprising:
receiving, by a processor, one or more inputs comprising assets, an income pattern, a retiree's age, and an annuity start date;
selecting, by the processor, an initial annuity payment corresponding to the annuity start date;
generating, by the processor, a periodic withdrawal stream, such that:
a total income stream, comprising the periodic withdrawal stream, matches the income pattern, and
the total income stream at a period of the annuity start date matches the initial annuity payment;
identifying, by the processor, a period number at which the assets remaining, before a withdrawal is made at the period number, are less than the total income stream at the period number, wherein the period number is identified based on drawing an amount corresponding to the periodic withdrawal stream from the assets each period before the period number;
comparing, by the processor, the period number to the period of the annuity start date and performing one of:
increasing, by the processor, the initial annuity payment in response to the period number falling after the period of the annuity start date;
decreasing, by the processor, the initial annuity payment in response to the period number falling before the period of the annuity start date; or
setting, by the processor, the annuity purchase amount based on the selected initial annuity payment, the retiree age, and the annuity start date in response to the period number being equal to the period of the annuity start date.

2. The method of claim 1, wherein the generating of the periodic withdrawal stream comprises generating the periodic withdrawal stream based on at least the assets net of the annuity purchase amount.

3. The method of claim 2, further comprising excluding a set-aside amount from the assets in the identifying of the period number.

4. The method of claim 1, further comprising adjusting, by the processor, the assets available at the period number based on the periodic withdrawal stream and a rate of return on the assets being equal to a first projected rate of return.

5. The method of claim 4, further comprising excluding a cushion amount from the assets remaining in the identifying of the period number.

6. The method of claim 4, further comprising:
determining, by the processor, an underperformance probability that the adjusted assets will be drawn to zero by the periodic withdrawal stream at a period number before the identified period number, based on the rate of return being equal to a second projected rate of return that is less than the first projected rate of return; and
determining, by the processor, a set-aside amount of the assets based on an amount required to reduce the underperformance probability below a threshold,
wherein the set-aside amount is excluded from the assets in the identifying of the period number and included in the assets when determining the underperformance probability.

7. The method of claim 4 further comprising:
generating a new periodic withdrawal stream based on the first projected rate of return while adjusting the assets based on a second projected rate of return;
generating an alternate periodic withdrawal stream comprising the periodic withdrawal stream in a first period before the annuity start date and the new periodic withdrawal stream in a second period before the annuity start date;
determining the set-aside amount based on a net present value of a difference between the periodic withdrawal stream and the alternate periodic withdrawal stream; and excluding the set-aside amount from the assets in the identifying of the period number.

8. The method of claim 4, wherein the assets comprise, at least in part, a reverse mortgage and wherein at least a portion of the reverse mortgage is included in one or more of:
the annuity purchase amount;
a set-aside amount excluded from the assets in the identifying of the period number;
a cushion amount excluded from the assets remaining in the identifying of the period number; or
assets from which the periodic withdrawal stream is drawn,
wherein a property rate of return applied to the reverse mortgage in the adjusting of the assets is different from the first projected rate of return.

9. The method of claim 1, wherein the identified period number corresponds to a period number at which the assets are drawn down to zero.

10. The method of claim 1, wherein the receiving further comprises receiving an input corresponding to a supplemental income stream;
wherein the total income stream further comprises the supplemental income stream;
wherein the identifying comprises identifying a period number at which a combination of the supplemental income stream and the assets remaining, before a withdrawal is made at the period number, is less than the total income stream at the period number; and
wherein the generating of the periodic withdrawal stream comprises generating the periodic withdrawal stream based on the assets, net of the annuity purchase amount, and the supplemental income stream.

11. The method of claim 1 further comprising displaying, by the processor, the annuity purchase amount.

12. A system for planning withdrawals from a pool of assets, the system comprising:
an input device configured to receive, from a user, inputs corresponding to assets, an income pattern, a retiree's age, and an annuity start date;
a communications interface device configured to obtain data corresponding to annuity pricing;
a processor and memory configured to:
select an initial annuity payment;
generate a periodic withdrawal stream, such that:
a total income stream, comprising the periodic withdrawal stream, matches the income pattern, and
the total income stream at a period of the annuity start date matches the initial annuity payment, and;
identify a period number at which the assets remaining, before a withdrawal is made at the period number, are less than the total income stream at the period number, wherein the period number is identified based on drawing an amount corresponding to the periodic withdrawal stream from the assets each period before the period number;
compare the period number to the period of the annuity start date and perform one of:
increasing the initial annuity payment in response to the period number falling after the period of the annuity start date;
decreasing the initial annuity payment in response to the period number falling before the period of the annuity start date; or
setting an annuity purchase amount, based on the selected initial annuity payment, the retiree age, the annuity pricing, and the annuity start date, in response to the period number being equal to the period of the annuity start date.

13. The system of claim 12, wherein the generating of the periodic withdrawal stream comprises generating the periodic withdrawal stream based on at least the assets net of the annuity purchase amount.

14. The system of claim 13, wherein the processor and memory are further configured to exclude a set-aside amount from the assets in the identifying of the period number.

15. The system of claim 13, wherein the processor and memory are further configured to exclude a cushion amount from the assets remaining in the identifying of the period number.

16. The system of claim 12, wherein the processor and memory are further configured to adjust the assets available at the period number based on the periodic withdrawal stream and a rate of return on the assets being equal to a first projected rate of return.

17. The system of claim 16, wherein the processor and memory are further configured to:
determine an underperformance probability that the adjusted assets will be drawn to zero by the periodic withdrawal stream at a period number before the identified period number, based on the rate of return being equal to a second projected rate of return that is less than the first projected rate of return; and
determine a set-aside amount of the assets based on an amount required to reduce the underperformance probability below a threshold,
wherein the set-aside amount is excluded from the assets in the identifying of the period number and included with the assets when determining the underperformance probability.

18. The system of claim 16, wherein the processor and memory are further configured to determine a set-aside amount of the assets by:
generating a new periodic withdrawal stream based on the first projected rate of return while adjusting the assets based on a second projected rate of return;
generating an alternate periodic withdrawal stream comprising the periodic withdrawal stream in a first period before the annuity start date and the new periodic withdrawal stream in a second period before the annuity start date;
determining the set-aside amount based on a net present value of a difference between the periodic withdrawal stream and the alternate periodic withdrawal stream;
excluding the set-aside amount from the assets in the identifying of the period number.

19. The system of claim 16, wherein the assets comprise, at least in part, a reverse mortgage and wherein at least a portion of the reverse mortgage is included in one or more of:
the annuity purchase amount;
a set-aside amount excluded from the assets in the identifying of the period number;
assets from which the periodic withdrawal stream is drawn,
wherein a property rate of return applied to the reverse mortgage in the adjusting of the assets is different from the first projected rate of return.

20. The system of claim 12, wherein the identified period number corresponds to a period number at which the assets are drawn down to zero.

21. The system of claim 12, wherein the input device is further configured to receive input corresponding to a supplemental income stream;
wherein the total income stream further comprises the supplemental income stream;
wherein the processor is further configured to identify a period number at which a combination of the supplemental income stream at the period number and the assets remaining, before a withdrawal is made at the period number, is less than the total income stream at the period number; and
wherein the processor is further configure to generate the periodic withdrawal stream based on the assets net of the annuity purchase amount and the supplemental income stream.

22. A computer readable medium storing instructions which, when executed by a computer, cause the computer to:
receive one or more inputs comprising assets, an income pattern, a retiree's age, and an annuity start date;
select an initial annuity payment corresponding to the annuity start date;
generate a periodic withdrawal stream, such that:
a total income stream, comprising the periodic withdrawal stream, matches the income pattern, and
the total income stream at a period of the annuity start date matches the initial annuity payment, and;
identify a period number at which the assets remaining, before a withdrawal is made at the period number, are less than the total income stream at the period number, wherein the period number is identified based on drawing an amount corresponding to the periodic withdrawal stream from the assets each period before the period number;
compare the period number to the period of the annuity start date and perform one of:
increasing the initial annuity payment in response to the period number falling after the period of the annuity start date;
decreasing the initial annuity payment in response to the period number falling before the period of the annuity start date; or
setting an annuity purchase amount, based on the selected initial annuity payment, the retiree age, and the annuity start date, in response to the period number being equal to the period of the annuity start date.
